(19) United States
(12) Patent Application Publication
(10) Pub. No.: US 2003/0088498 A1
(43) Pub. Date: May 8, 2003

(54) System and method for automatically providing financial documents

(76) Inventors: Patrick R. Clark, White House, TN (US); Frederick Martin, Hendersonville, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/016,015

(22) Filed: Oct. 26, 2001

(51) Int. Cl. G06F 17/60

(52) U.S. Cl. 705/37

(57) ABSTRACT

A computer based system and method automatically creates a custom package of financing documents. The system and method requests a decision criteria document and presents the decision criteria document to a user. The decision criteria document includes a plurality of data fields to be completed by the user. The system and method also receive completed data fields from the user and automatically select a required set of documents based on the completed data fields.

### TECHNICAL FIELD

The present invention relates generally to financial documents, and more particularly, to a system and method for automatically providing financial documents.

### BACKGROUND

The purchase or lease of equipment, such as construction equipment, engines, etc., is a very detailed process involving complicated financing decisions and financial documents. The process involves determining the type of financing available for the customer, as well as geographic factors. Additionally, depending on the type of financing and the geographic location of the customer, the number, type, as well as the terms of, the documents required vary.

In a typical sale or lease, the first step includes a quoting process. The quoting process involves a discussion with the customer, generally, including determining the equipment which the customer desires to lease or purchase and type and size of desired payment.

The second step is the credit process. The credit process involves requesting and receiving the customer credit scoring from a credit bureau. The credit scoring are used to determine the type of financing available to the customer. Other factors, may also a be used to determine the type of financing available, such as the customer's payment history on past purchases or leases.

Once the financing terms have been arranged, the financing documents must be prepared. As discussed above, the number and type of documents, as well as specific clauses or terms in the financing documents will vary. Factors includes customer, the lessor, the geographic location, and the type of financing. The lessor is generally a subsidiary of the financing company in a particular country. There may be more than one lessor in each country, based on different factors, e.g., currency of the transaction.

Historically, the financing documents were manually prepared by a finance analyst for each transaction. This manual process is time consuming, expensive, and susceptible to errors. More recently, the finance analyst has manually prepared a list of the required financing documents identifying all of the needed parameters and/or terms. This list was then delivered to an automated remote documents computer system which generated the documents. However, the process of manually preparing the list and terms of the required financing documents is also time consuming, expensive, and susceptible to errors.

The present invention is aimed at one or more of the problems addressed above.

### SUMMARY OF THE INVENTION

In one aspect of the present invention, A computer based method for automatically creating a list of financing documents for a contract, is provided. The includes the steps of requesting a decision criteria document and preparing the decision criteria document. The decision criteria document having a plurality of data fields to be completed. The method also includes the steps of receiving completed data fields and automatically selecting a required set of documents based on the completed data fields and preparing the list of financing documents.

In another aspect of the present invention, a computer based system for automatically creating a list of financing documents. The system includes a finance computer application located at a first location and an auto-packaging computer application coupled to the finance computer application located at a second location. The auto-packaging computer application is adapted to receive a request for a decision criteria document from the finance computer application and prepare the decision criteria document. The decision criteria document includes a plurality of data fields to be completed. The finance computer application is adapted to receive completed data fields from the finance computer application, automatically select a required set of documents based on the completed data fields and prepare the list of financing documents.

### BRIEF DESCRIPTION OF THE DRAWINGS

FIG. 1 is a flow diagram of a transaction process including a document preparation process, according to an embodiment of the present invention;

FIG. 2 is a block diagram of a system for automatically creating a list of financing documents for a transaction and automatically providing the documents, according to an embodiment of the present invention;

FIG. 3 is a block diagram of a computer program product, according to an embodiment of the present invention;

FIG. 4 is a first flow diagram of a method for automatically creating a list of financing documents for a transaction and automatically providing the documents, according to an embodiment of the present invention; and,

FIG. 5 is a second flow diagram of a method for automatically creating a list of financing documents for a transaction and automatically providing the documents, according to another embodiment of the present invention.

### DETAILED DESCRIPTION

With reference to the drawings, and in operation, the present invention provides a computer based system 200 and a method 400, 500 for automatically creating a list of financing documents for a transaction.

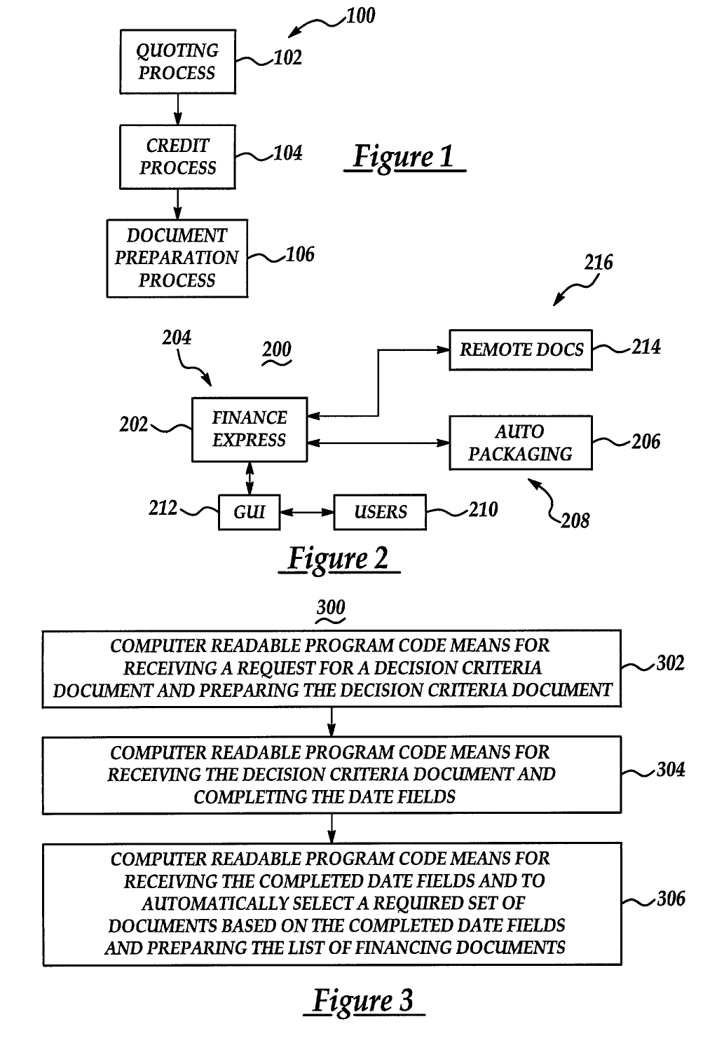

With specific reference to FIG. 1, the present invention may be utilized for the creation of a purchasing or leasing transaction 100 for construction equipment. As described above, there may be three basic functions during the creation process: a quoting process (flow block 102), a credit process (flow block 104), and a document preparation process (flow block 106).

Generally, a customer desires to purchase or lease one or more pieces of equipment, construction or agricultural equipment, engines, or any type of equipment or item which may be bought or sold. The customer contacts a sales agent, who may be located at either a dealer of the construction equipment or at a financing company. Alternatively, this process may be accomplished by the customer through a computer network, such as the internet, using an interactive user interface.

In a quoting process 102, the agent works with the customer and determines the equipment which the customer wished to purchase or lease and the maximum monthly payment the customer desires.

In one embodiment of the credit process 104, the sales agent requests a credit scoring for the customer from a credit bureau. This information, along with other information regarding the customer's history with the financing company, is used to determine whether to extend credit to the customer for the purchase or lease of the equipment and, if so, under what terms.

During the quoting and credit processes 102, 104, the sales agent requests and receives from the customer, transaction information. As described below, the agent enters this information into the system 200.

With specific reference to FIG. 2, the computer system 200 for automatically creating a list of financing documents for a transaction, according to an embodiment of the present invention, will now be described.

The system 200 includes a finance computer application 202 implemented on a computer system (not shown) located at a first location 204. An auto-packaging computer application 206 implemented on a second computer system (not shown). The auto-packaging computer application 206 is coupled to the finance computer application 202 and is located at a second location 208.

The auto-packaging computer application 206 is adapted to receive a request for a decision criteria document from the finance computer application 202 and prepare the decision criteria document. The decision criteria document includes a plurality of data fields to be completed.

As discussed below, the finance computer application 202 completes the data fields and sends the completed decision criteria document back to the auto-packaging computer application 206.

Based on the completed data fields of the decision criteria document, the auto-packaging computer application 206 selects a required set of documents and prepares the list of financing documents.

Preferably, a user 210 interacts via a graphic user interface 212 to input the transaction information during the quoting and credit processes 102, 104. In response to a user request, the finance computer application 202 sends the request for the decision criteria document to the auto-packaging computer application 206.

In response to receiving the request for a decision criteria document, the auto-packaging computer application 206 is adapted to request initial information from the finance computer application in response to receiving the request for a decision criteria document and to receive the initial information from the finance computer application, wherein the data fields of the decision criteria document are determined as a function of the initial information.

In one embodiment, the initial information is determined or contained in the transaction information and gleaned automatically by the finance computer application 202. In one embodiment, the initial information includes a contract type, a country code, and a lessor number. The contract type may includes, but not limited to a lease, a loan, an installment contract, or a governmental lease.

In one embodiment, the decision criteria document is in extended markup language (XML). Additionally, the finance computer application 202 is adapted to allow the user to override the required set of documents. Preferably, the required set of documents includes a primary document and at least one supporting document. In one embodiment, each document in the list of financing documents includes:

a document name,

a number of copies, and

a simplex/duplex code.

Additionally, each document may include:

a document type (primary contract or supporting paper),

a description,

an association with other documents, and,

an effective date and an inactive date (where applicable).

Associated with each document are also a set of selection rules which determine the conditions under which the document is to be included in the documentation package. The selection rules are based upon values of specific data elements in the deal or agreement. In one embodiment, all of the specifics and rules of the documents are contained in tables. Documents can be added or inactivated as needed. Old rules may also be added or inactivated as required.

For example, a form, as an Attachment, may be user to describes the equipment for which the contact is being drafted. The form may be used when more than eight (8) pieces of equipment are at issue. Thus, the selection criteria rule is written as indicated below:

| Field Name | Operator | Value1 |
|---|---|---|
| Num_Assets | > | 8 |

The value of Num_Assets is received from the finance computer application 202.

In another example, form CISCDIR is an insurance form used when insurance is sold directly to the customer without a licensed dealer. The selection criteria rule is indicated below:

| Field Name | Operator | Value 1 |
|---|---|---|
| dir_state | < > | TX |
| dir_insurance_status | = | UNLICENSED |
| customer_state | not in list | HI, AK |
| cat_insurance | = | true |
| self_insured | = | false |

The auto-packaging computer application 206 sends the list of required documents to the finance computer application 202.

As shown, the system 200 further includes a remote docs computer application 214 which may be implemented on a third computer system which may be located at a third location 216.

In one embodiment, the finance computer application 202 sends the list to the remote docs computer application 214. Additionally, the finance computer application 202 sends required data to be merged into the documents. The remote docs computer application is an automatic document delivery system which receives the list, automatically generates the required documents and returns the required documents to the user 210 via the finance computer application 202 and the GUI 212.

With reference to FIG. 3, the system 200 is implemented in a computer program product 300 for automatically creating a list of financing documents for a transaction. The computer readable program code includes:

computer readable program code means 302 for receiving a request for a decision criteria document and preparing the decision criteria document, the decision criteria document having a plurality of data fields to be completed,

computer readable program means 304 for receiving the decision criteria document and completing the data fields, and,

computer readable program means 306 for receiving the completed data fields and to automatically select a required set of documents based on the completed data fields and preparing the list of financing documents.

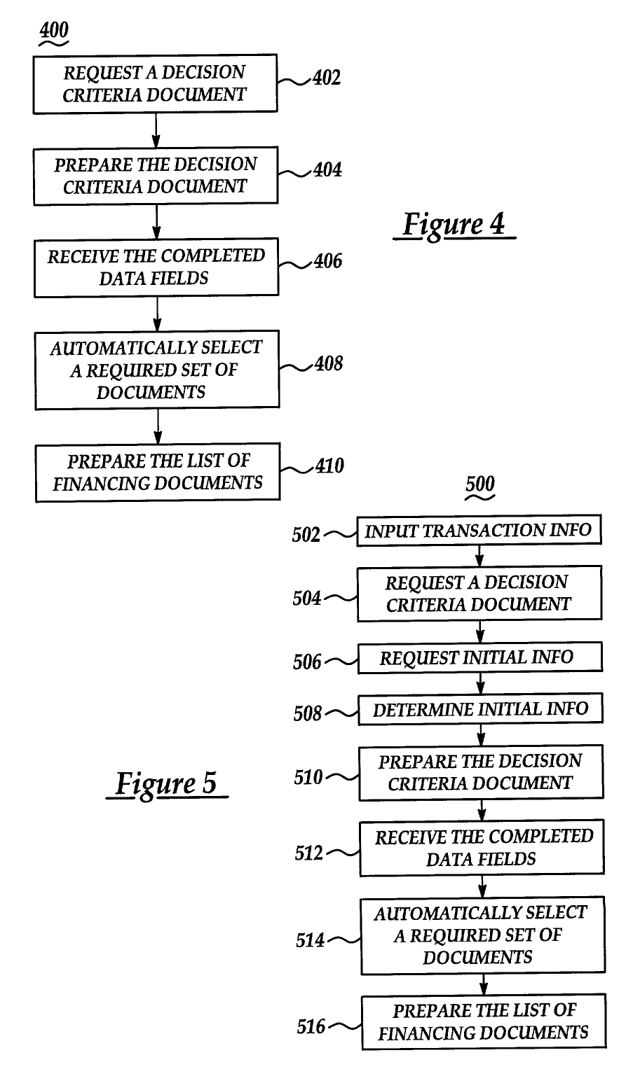

With reference to FIG. 4, a computer based method 400 for automatically creating a list of financing documents for a transaction, according to an embodiment of the present invention will now be described. In a first process block 402, a decision criteria document is requested. In one embodiment, this is done through the finance computer application 202. In a second process block 404, the auto-packaging computer application 206 prepares the decision criteria document. As discussed above, the decision criteria document includes a plurality of data fields to be completed. In a third process block 406, the data fields are completed by the finance computer application 202 and received by the auto-packaging computer application 206. In a fourth process block 408, the auto-packaging computer application 206 automatically selects a required set of documents based on the completed data fields. In a fifth process block 410, the auto-packaging computer application 206 prepares the list of financing documents.

In one embodiment, the user 210 inputs transaction information and initiates the request for the decision criteria document. The auto-packaging computer application 206 requests initial information in response to receiving the request for the decision criteria document. Preferably, the request for initial information is received by the finance computer application 202. The initial information is then gleaned from the transaction information by the finance computer application 202 and sent to the auto-packaging computer application 206.

In one embodiment, the initial information includes a contract type, a country code, and a lessor number. The contract type may be, but is not limited to a lease, a loan, an installment contract, and a governmental lease.

With specific reference to FIG. 4, a computer based method 500 for automatically creating a list of financing documents for a transaction, according to another embodiment of the present invention will now be described. In a sixth process block 502, the user 210 inserts and inputs transaction information. Typically, this is done during the quoting and credited processes 102, 104. In a seventh process block 504, the finance computer application 202 in response to action by the user 210 requests a decision criteria document from the auto-packaging computer application 206. In response, in an eighth process block 506 the auto-packaging computer application 206, requests initial information from the finance computer application 202.

In a ninth process block 508, the initial information is determined from the transaction information. In a tenth process block 510, the decision criteria document is prepared based on the initial information. The decision criteria document has a plurality of data fields to be completed. The decision criteria document is preferably in extended markup language (XML).

In an eleventh process block 512, the data fields are completed by the finance computer application 202 and the completed data fields are received by the auto-packaging computer application 206.

In a twelfth process block 514, the auto-packaging computer application 206 automatically selects a required set of documents based on the completed data fields and prepares the list of financing documents.

### INDUSTRIAL APPLICABILITY

With specific reference to FIG. 1, the present invention provides a system and method 200, 400, 500 for automatically creating a list of financing documents for a transaction. The system and method 200, 400, 500, in practice, are generally part of a sale or lease transaction for, e.g., construction equipment. The customer (purchaser or lessee) interacts with an employee (sales agent) of a dealer, a financial company or the manufacturer or with a user interface, e.g., a web site.

As described above, there are generally three steps to the transaction: the quoting process, the credit process and the document preparation process.

In the quoting process, the customer and the sales agent discuss the type and number of equipment, the type of contract, and the maximum size payment the client desires. After these are determined, the agent performs a credit check on the customer to determine whether or not to extend the desired credit to the customer. Past customer conduct with respect to payment history to the financial company may also be considered. After the credit process, the transaction documents needs to be prepared. The auto-packaging computer application 204 generates a list of the required documents using information gathered during the quoting process and the credit process. Additional information regarding the customer may be retrieved from other systems, e.g., the customer's past credit history with the finance company. After receiving the list generated by the auto-packaging computer application 204, the finance computer application 202 sends the list to the remote documents computer application 214. The remote documents computer application 214 retrieves the documents and delivers the documents to the finance computer application.

Other aspect and features of the present invention can be obtained from a study of the drawings, the disclosure, and the appended claims.

What is claimed is:

1. A computer based method for automatically creating a list of financing documents for a transaction, the method including the steps of:
requesting a decision criteria document;
preparing the decision criteria document, the decision criteria document having a plurality of data fields to be completed;
receiving completed data fields; and, automatically selecting a required set of documents based on the completed data fields and preparing the list of financing documents.

2. A computer based method, as set forth in claim 1, including the steps of:
requesting initial information; and, receiving the initial information; wherein the data fields of the decision criteria document are determined as a function of the initial information.

3. A computer based method, as set forth in claim 2, including the step of inserting transaction information by a user, wherein the initial information is automatically determined from the transaction information.

4. A computer based method, as set forth in claim 2, wherein the initial information includes a contract type, a country code, and a lessor number.

5. A computer based method, as set forth in claim 4, wherein the contract type is one of a lease, a loan, an installment contract, and a governmental lease.

6. A computer based method, as set forth in claim 1, wherein the decision criteria document is in extended markup language.

7. A computer based method, as set forth in claim 1, including the step of allowing a user to override the required set of documents.

8. A computer based method, as set forth in claim 1, wherein the required set of documents includes a primary document and at least one supporting document.

9. A computer based method, as set forth in claim 1, wherein each document in the list of financing documents includes a document name, a number of copies, and a simplex/duplex code.

10. A computer based method, as set forth in claim 1, including the step providing a list of the required set of documents to a user.

11. A computer based method, as set forth in claim 1, including the step of providing the required set of documents.

12. A computer based method for automatically creating a list of financing documents for a transaction, the method including the steps of:
inserting transaction information by a user;
requesting a decision criteria document;
requesting initial information in response to the request for a decision criteria document;
determining the initial information from the transaction information;
preparing the decision criteria document, the decision criteria document having a plurality of data fields as a function of the initial information;
receiving completed data fields; and,
automatically selecting a required set of documents based on the completed data fields and preparing the list of financing documents.

13. A computer based method, as set forth in claim 12, including the step of providing a graphical user interface for interaction with the user.

14. A computer based method, as set forth in claim 12, wherein the initial information includes a contract type, a country code, and a lessor number.

15. A computer based method, as set forth in claim 14, wherein the contract type is one of a lease, a loan, an installment contract, and a governmental lease.

16. A computer based method, as set forth in claim 12, wherein the decision criteria document is in extended markup language.

17. A computer based method, as set forth in claim 12, including the step of allowing the user to override the required set of documents.

18. A computer based method, as set forth in claim 12, wherein the list of financing documents includes a primary document and at least one supporting document.

19. A computer based method, as set forth in claim 12, wherein each document in the required set of documents includes a document name, a number of copies, and a simplex/duplex code.

20. A computer based method, as set forth in claim 12, including the step providing a list of the required set of documents to the user.

21. A computer based method, as set forth in claim 12, including the step of providing the required set of documents.

22. A computer based system for automatically creating a list of financing documents for a transaction, comprising:
a finance computer application located at a first location; and,
an auto-packaging computer application coupled to the finance computer application and being located at a second location, the auto-packaging computer application being adapted to receive a request for a decision criteria document from the finance computer application and prepare the decision criteria document, the decision criteria document having a plurality of data fields to be completed, to receive completed data fields from the finance computer application, and to automatically select a required set of documents based on the completed data fields and preparing the list of financing documents.

23. A computer based system, as set forth in claim 22, wherein the auto-packaging computer application is adapted to request initial information from the finance computer application in response to receiving the request for a decision criteria document and to receive the initial information from the finance computer application, wherein the data fields of the decision criteria document are determined as a function of the initial information.

24. A computer based system, as set forth in claim 24, wherein the finance computer application is adapted to receive transaction information from a user, wherein the initial information is determined from the transaction information.

25. A computer based system, as set forth in claim 23, wherein the initial information includes a contract type, a country code, and a lessor number.

26. A computer based system, as set forth in claim 25, wherein the contract type is one of a lease, a loan, an installment contract, and a governmental lease.

27. A computer based system, as set forth in claim 22, wherein the decision criteria document is in extended markup language.

28. A computer based system, as set forth in claim 22, wherein the finance computer application is adapted to allow the user to override the required set of documents.

29. A computer based system, as set forth in claim 22, wherein the required set of documents includes a primary document and at least one supporting document.

30. A computer based system, as set forth in claim 22, wherein each document in the list of financing documents includes a document name, a number of copies, and a simplex/duplex code.

31. A computer based system, as set forth in claim 22, including a remote documents computer application, wherein the finance computer application is adapted to send the list of finance documents to the remote documents computer application and the remote documents computer application is adapted to responsively provide the required set of documents.

32. A computer based system for automatically creating a list of financing documents, comprising:
a finance computer application located at a first location, the finance computer application being adapted to be operated by a user;
an auto-packaging computer application coupled to the finance computer application and being located at a second location, the auto-packaging computer application being adapted to receive a request for a decision criteria document from the finance computer application and prepare the decision criteria document, the decision criteria document having a plurality of data fields to be completed, to receive completed data fields from the finance computer application, and to automatically select a required set of documents based on the completed data fields and preparing the list of financing documents; and,
a graphical user interface implemented on the finance computer application for interaction with the user.

33. A computer based system, as set forth in claim 32, wherein the auto-packaging computer application is adapted to request initial information from the finance computer application in response to receiving the request for a decision criteria document and to receive the initial information from the finance computer application, wherein the data fields of the decision criteria document are determined as a function of the initial information.

34. A computer based system, as set forth in claim 33, wherein the finance computer application is adapted to receive transaction information from the user, wherein the initial information is determined from the transaction information.

35. A computer based system, as set forth in claim 33, wherein the initial information includes a contract type, a country code, and a lessor number.

36. A computer based system, as set forth in claim 35, wherein the contract type is one of a lease, a loan, an installment contract, and a a governmental lease.

37. A computer based system, as set forth in claim 32, wherein the decision criteria document is in extended markup language.

38. A computer based system, as set forth in claim 32, wherein the finance application is adapted to allow the user to override the required set of documents.

39. A computer based system, as set forth in claim 32, wherein the required set of documents includes a primary document and at least one supporting document.

40. A computer based system, as set forth in claim 32, wherein each document in the required set of documents includes a document name, a number of copies, and a simplex/duplex code.

41. A computer based system, as set forth in claim 32, including a remote documents computer application, wherein the finance computer application is adapted to send the list of finance documents to the remote documents computer application and the remote documents computer application is adapted to provide the required set of documents.

42. A computer program product for automatically creating a list of financing documents for a transaction, the computer program product, comprising:
computer readable program code means for receiving a request for a decision criteria document and preparing the decision criteria document, the decision criteria document having a plurality of data fields to be completed;
computer readable program means for receiving the decision criteria document and completing the data fields; and,
computer readable program means for receiving the completed data fields and to automatically select a required set of documents based on the completed data fields and preparing the list of financing documents.
